(19) United States
(12) Patent Application Publication
(10) Pub. No.: US 2018/0094336 A1
(43) Pub. Date: Apr. 5, 2018

(54) PROCESS FOR PREPARING METAL POWDERS AND METAL HYDRIDE POWDERS OF THE ELEMENTS TI, ZR, HF, V, NB, TA AND CR

(71) Applicant: ALBEMARLE GERMANY GMBH, Frankfurt am Main (DE)

(72) Inventors: Manfred Bick, Oberursel (DE); Bernd Sermond, Aßlar (DE); Gerhard Wilfing, Cölbe (DE)

(21) Appl. No.: 15/705,721

(22) Filed: Sep. 15, 2017

Related U.S. Application Data
(63) Continuation of application No. 10/564,427, filed on Feb. 1, 2006, now abandoned.

(30) Foreign Application Priority Data
Jul. 15, 2003 (DE) 103 32 033.4

(51) Int. Cl. C22B 34/00; C01B 6/02; C22B 34/14; B22F 9/20; C22B 5/04

(52) U.S. Cl. CPC C22B 34/00; Y02P 10/234; B22F 2998/10; C22B 3/10; C22B 34/14; B22F 9/20; C22B 5/04; C01B 6/02

(57) ABSTRACT

A method for the production of metal powders or metal hydride powders of the elements Ti, Zr, Hf, V, Nb, Ta, and Cr is disclosed, whereby an oxide of the said elements is mixed with a reducing agent and said mixture, optionally with a hydrogen atmosphere (for the production fo metal hydrides), is heated until the reduction reaction commences, the reaction product is quenched, then washed and dried. The oxide used has an average particle size of 0.5 to 20 μm, a BET specific surface of 0.5 to 20 m²/g and a minimum content of 94 wt %.

### REFERENCE TO RELATED APPLICATIONS

This is a continuation of commonly-owned, co-pending U.S. application Ser. No. 10/564,427, filed Feb. 1, 2006, which is a § 371 of PCT/EP2004/007032 filed Jun. 29, 2004, which claims priority from German Patent Application No. 103 32 033.4 filed Jul. 15, 2003.

The invention provides a process for preparing metal powders and metal hydride powders of the elements Ti, Zr, Hf, V, Nb, Ta and Cr.

Metal powders of the elements Ti, Zr, Hf, V, Nb, Ta and Cr and powdered hydrides of these metals are used, for example, in the following areas of application: titanium for the production of titanium components for the aircraft and automobile industries, for the production of titanium alloys and for the production of sintered AlNiCo magnets; titanium, zirconium and hafnium in the pyro-industry, for the production of electric detonator systems (e.g., in airbags) and ignition delay elements, in getter materials in vacuum tubes, lamps, vacuum equipment and gas purification plants; hafnium as an alloying element in niobium, tantalum, titanium, molybdenum and tungsten alloys; vanadium as an alternative metal electrode in metal-hydride/nickel-hydride batteries and in TiAl₆V₄ alloys; niobium in the production of equipment for the chemicals industry and as an alloying element for ZrNb alloys (nuclear industry) and NbHfTi alloys (highly heat resistant materials for jet engines or explosion chambers); tantalum in capacitors.

As a result of the sometimes very high requirements placed on the reliability of the products mentioned above (e.g. airbag detonators), it is desirable to produce the metal powders or metal hydride powders reproducibly and with identical properties from batch to batch (in particular with respect to burning time, ignition point, mean particle size, particle size distribution and oxidation value).

The metal powders can be produced by a reduction process. In this case, oxides of the metals (Ti, Zr, Hf, V, Nb, Ta and Cr) are reduced, for example with calcium or calcium hydride. The reduction process is performed in a vessel which can be sealed, rendered inert and evacuated. The reducing agents (s) are normally added in excess. After reduction, the oxides of the reducing agents being produced are removed by leaching with acid and then washing with water. The acid content of the metal powder obtained is between 1 and 5% when using this method.

Alternatively, the metal powders can be obtained from the relevant metal by hydrogenation and dehydrogenation (HDH method). The relevant metal is hydrogenated and, in this then brittle form, can be crushed mechanically to give powders of the desired fineness. In order to avoid damage due to the uptake of oxygen and nitrogen, ultrapure hydrogen has to be used for the hydrogenation process. Crushing the hydrogenated metal to the desired particle size must also be performed in a pure protective gas atmosphere (e.g. helium or argon). Subsequent removal of the hydrogen is achieved by decomposing the metal hydride under vacuum at elevated temperature. Metal hydride powders are produced in the same way. The dehydrogenation process is then simply omitted.

A disadvantage of the metal powders and hydrides produced in this way is, inter alia, that these do not have reproducible burning times, reproducible specific surface areas, reproducible particle size distributions or reproducible ignition points.

The object of the invention is to overcome the disadvantages of the prior art and to provide metal powders and metal hydride powders of the elements Ti, Zr, Hf, V, Nb, Ta and Cr that have a burning time of 4 s per 50 cm to 3000 s per 50 cm and an ignition point of 160° C. to 400° C. and above this in individual cases.

The burning time, expressed in s/50 cm is determined as follows. The substance being tested is first sieved through two sieves with mesh sizes of 250 μm and 45 μm in order to eliminate problematic agglomerates. Optionally, the sample can be carefully moved about with a brush during this procedure. The fine material that has passed through the 45 μm sieve is used to determine the burning time. 15 g of the sample are placed loosely in a metal channel, described below, smoothed out with a piece of cardboard and any excess removed by wiping it off. The metal channel is provided with two marks that are located at a spacing of 500 mm from each other. Upstream of the first mark, an additional approximately pea-sized amount of substance is applied and is ignited with a burner. With the aid of a time-exposure photograph, the time required to pass through the distance between the first and the last mark is now determined. The analytical result for burning time is cited with the dimensions [s/50 cm].

The ignition point is determined as follows: 10 g of the substance being tested are introduced into a pre-heated so-called “ignition block” and the temperature at which self-ignition occurs is measured. The ignition block, consisting of an iron cube with an edge-length of 70 mm and with drilled holes for the material and a thermocouple (20 mm and 8 mm diameter, each hole 35 mm deep, distance between mid-points of hole 18 mm), is preheated to a temperature slightly below the ignition temperature, using a blowlamp, after inserting the thermometer or thermocouple in the drilled hole provided for this purpose. This temperature is determined using a trial sample. A heaped spatula (10 g) of the metal powder or hydride being tested is now introduced into the material hole in the pre-heated ignition block and the block is heated with a full blowlamp flame until the powder self-ignites. The temperature reached at that time is the ignition point.

Furthermore, it is desirable that the metal powder or metal hydride powder has a metal or metal hydride content of at least 75 wt. %, preferably at least 88 wt. %, particularly preferably 90 wt. %, a mean particle diameter of 1 to 15 μm, a preferred particle size distribution (measured by means of laser diffraction) of 1 to 20 μm and a BET specific surface area of 0.2 to 5 m²/g.

The mean particle diameter is determined as follows using a “Fisher sub-sieve size particle sizer” (called FSSS in the following). A description of this method of measurement can be found in “Instructions, Fisher Model 95 Sub-Sieve Sizer, catalog number 14-311, part no. 14579 (rev. C), published 01-94” from Fisher Scientific. Express reference is made here to this description of the measurement process.

The object is achieved by a process for preparing metal powders or metal hydride powders of the elements Ti, Zr, Hf, V, Nb, Ta and Cr, in which an oxide of these elements is mixed with a reducing agent and this mixture is heated in an oven, optionally under an atmosphere of hydrogen (metal hydrides are then formed), until the reduction reaction starts, the reaction product is leached and then the product is washed and dried, wherein the oxide used has a mean particle size of 0.5 to 20 pm, preferably 1 to 6 μm, a BET specific surface area of 0.5 to 20 m²/g, preferably 1 to 12 m²/g, and particularly preferably 1 to 8 m²/g, and a minimum content of 94 wt. %, preferably 96 wt. % and particularly preferably 99 wt. %.

The proportion of Fe and Al impurities in the oxide is preferably<0.2 wt. %, particularly preferably<0.1 wt. % each (each calculated as the oxide). The proportion of Si impurities in the oxide is preferably<1.5 wt. %, particularly preferably<0.3 wt. % (calculated as SiO₂). The proportion of Na impurities in the oxide is preferably<0.05 wt. % (calculated as Na₂O). The proportion of P impurities in the oxide is preferably<0.2 wt. % (calculated as P₂O₅). The loss on ignition of the oxide at 1000° C. (constant weight) is preferably<1 wt. %, particularly preferably<0.5 wt. %. The tamped down bulk density according to EN ISO 787-11 (previously DIN 53194) of the oxide is preferably 800 to 1600 kg/m³. A proportion of up to 15 wt. % of the oxide can be replaced by additives consisting of MgO, CaO, Y₂O₃ or CeO₂.

It was found that, by targeted selection of the oxidic raw materials with the properties described above and then performing the process, products are obtained that have a burning time of 4 s per 50 cm to 3000 s per 50 cm, an ignition energy of 1 μJ to 1 mJ, a mean particle size of 1 to 8 μm, a BET specific surface area of 0.2 to 5 m²/g, an ignition point of 160° C. to 400° C. and above that in individual cases, wherein reproducible particle size distributions are obtained in each case. The combination of average particle size and specific surface area within each of the ranges cited above for the oxidic starting compound, together with the minimum content cited, leads to the desired product.

The reducing agents preferably used may be: alkaline earth metals and alkali metals and the hydrides of each. Magnesium, calcium, calcium hydride and barium or defined mixtures of these are particularly preferred. The reducing agent preferably has a minimum content of 99 wt. %, particularly preferably 99.5 wt. %.

Powdered pure metals, partially hydrogenated metals or metal hydrides are obtained, depending on the amount of hydrogen added during the reduction process in the oven. The higher the hydrogen content of the process product, the greater is the burning time (i.e., the metal burns more slowly) and the higher the ignition point, and vice versa.

Leaching the reaction product is preferably performed with hydrochloric acid and this is particularly preferably used in a slight excess.

The invention is explained in more detail using the examples given below.

### EXAMPLE 1

### Preparation of Zirconium Powder

43 kg of ZrO₂ (powdered zirconium oxide (natural baddeleyite)) with the following properties: ZrO₂+HfO₂ min. 99.0%; HfO₂ 1.0-2.0%; SiO₂ max. 0.5%; TiO₂ max. 0.3%; Fe₂O₃ max. 0.1%; loss on ignition max. 0.5%; mean particle size (using FSSS) 4-6 μm; proportion of monoclinic crystal structure min. 95%; specific surface area (BET) 0.5-1.5 m²/g) and 31.5 kg of Ca (calcium in the form of granules with the following properties: Ca min. 99.3%; Mg max. 0.7%) were mixed for 20 minutes under an atmosphere of argon. Then the mixture was introduced into a container. The container was placed in an oven that was subsequently closed and filled with argon up to a pressure of 100 hPa above atmospheric pressure. The reaction oven was heated to a temperature of about 1250° C. over the course of one hour. As soon as the reaction material had reached the temperature of the oven, the reduction reaction started:

ZrO₂+2 Ca→Zr+2 CaO

60 minutes after switching on the oven heating system, it was then switched off. When the temperature had dropped to <50° C., the reaction material was removed from the crucible and leached with concentrated hydrochloric acid. A zirconium powder with the following analytical characteristics was obtained: Zr+Hf 96.1%; Hf 2.2%; O 0.7%; Si 0.21%; H 0.16%; Mg 0.11%; Ca 0.13%; Fe 0.07%; Al 0.1%; Cl 0.002%; mean particle size 4.9 μm; particle size distribution d₅₀ 9.9 μm; specific surface area 0.5 m²/g; ignition point 220° C.; burning time 80 sec/50 cm.

### EXAMPLE 2

### Preparation of Zirconium Powder

36 kg of ZrO₂ (powdered zirconium oxide with the following properties: ZrO₂+HfO₂ min. 99.0%; HfO₂ 1.0-2.0%; SiO₂ max. 0.2%; TiO₂ max. 0.25%; Fe₂O₃ max. 0.02%; loss on ignition max. 0.4%; mean particle size (using FSSS) 3-5 pm; proportion of monoclinic crystal structure min. 96%; specific surface area (BET) 3.0-4.0 m²/g) and 17 kg of Mg (magnesium in the form of granules with the following properties: Mg min. 99.8%; bulk density max. 0.4-0.5 g/cm³) were placed in a container in the oven, in the same way as described in example 1. The oven was heated to 1050° C. As soon as the reaction material reached the temperature of the oven, the reduction reaction started:

ZrO₂+2 Mg→Zr+2 MgO

The oven heating system was switched off 20 minutes after the start of the reduction reaction. When the temperature had dropped to <50° C., the reaction material was removed from the crucible and leached with concentrated hydrochloric acid. A zirconium powder with the following analytical characteristics was obtained: Zr+Hf 91.7%; O 1.6%; Si 0.14%; H 0.13%; Mg 0.59%; Ca<0.001%; Fe 0.045%; mean particle size 2.5 μm; particle size distribution d₅₀ 4.3 μm; ignition point 175° C.; burning time 24 sec/50 cm.

That which is claimed is:

1. A process for preparing a zirconium metal powder or a zirconium hydride powder comprising the steps of:
a) mixing zirconium oxide with solid calcium metal, solid magnesium metal, and/or solid barium metal, and mixtures of any two or more of the foregoing, to form a mixture, wherein the zirconium oxide has a mean particle size of 0.5 to 20 μm, a BET specific surface area of 0.5 to 20 m²/g and a minimum content of 94 wt %;
b) heating the mixture at 800 to 1400° C. in an oven, until a reduction reaction starts, to obtain a reaction product, wherein when forming a zirconium hydride, the reduction reaction occurs in a hydrogen atmosphere;
c) leaching the reaction product to obtain a leached product; and
d) washing and drying the leached product to yield the zirconium metal powder or zirconium hydride powder;
wherein the zirconium metal powder or the zirconium hydride powder has an oxygen content of 1.6% or less, an ignition energy of 1μJ to 1 mJ, a burning time of 4 s per 50 cm to 3000 s per 50 cm and an ignition point of from 160° C. to 400° C.

2. The process of claim 1, wherein the reducing agent is magnesium metal.

3. The process of claim 1, wherein the reducing agent is calcium metal.

4. The process of claim 1, wherein the reducing agent is barium metal.

5. A process according to claim 1, wherein the reducing agent has a minimum content of 99 wt %, and/or wherein the leaching is with hydrochloric acid.

6. A process as in claim 1 wherein the zirconium oxide has one or more of the following properties:
a BET specific surface area of 1 to 12 m²/g;
a mean particle size of 1 to 6 μm; and/or
a minimum content of 96 wt %.

7. A process according to claim 1, wherein the zirconium oxide has a BET specific surface area of 1 to 8 m²/g and/or a minimum content of 99 wt %.

8. The process of claim 1, wherein the zirconium oxide has a BET specific surface area of 0.5 to 1.5 m²/g.

9. The process of claim 1, wherein the zirconium oxide has a BET specific surface area of 0.5 to 1.5 m²/g, a mean particle size of 4 to 6 μm, and a minimum content of 99 wt %, and optionally wherein the reducing agent is calcium.

10. The process of claim 1, wherein the zirconium oxide has a BET specific surface area of 3 to 4 m²/g, a mean particle size of 3 to 5 μm, and a minimum content of 99 wt %, and optionally wherein the reducing agent is magnesium.

11. A process according to claim 1, wherein the zirconium oxide has one or more of the following properties:
the proportion of Fe and Al impurities in the oxide are each <0.2 wt %, calculated as the oxides;
the proportion of Si impurities in the oxide is <1.5 wt %, calculated as SiO₂;
the proportion of Na impurities in the oxide is<0.05 wt %, calculated as Na₂O; and/or
the proportion of P impurities in the oxide is<0.2 wt %, calculated as P₂O₅.

12. A process according to claim 11, wherein the content of Fe and Al impurities in the zirconium oxide are each <0.1 wt %; calculated as the oxide of said Fe and Al impurities, and/or wherein the content of Si impurities in the zirconium oxide is <0.3 wt %, calculated as SiO₂.

13. A process according to claim 1, wherein up to 15 wt % of the zirconium oxide is replaced by one or more additives selected from the group consisting of MgO, CaO, Y₂O₃ and CeO₂, and/or wherein the zirconium oxide has a loss on ignition of at 1000° C. at constant weight of<1 wt %, and/or wherein the zirconium oxide has a tamped down bulk density according to EN ISO 787-11 of 800 to 1600 kg/m³.

14. The process of claim 1, wherein the process consists of said mixing, heating, leaching, washing and drying steps.

15. A process as in claim 1, wherein said zirconium metal powder has a mean particle size of 1 μm to 8 μm.

16. A process as in claim 1 wherein the zirconium metal powder or zirconium hydride powder has a BET specific surface area of 0.2 to 5 m²/g and/or a mean particle size of 1 to 15 μm.

17. A process as in claim 1 wherein the zirconium metal powder or the zirconium hydride powder has a BET specific surface area of 0.2 to 5 m²/g and/or a mean particle size of 1 to 8 μm.

18. A zirconium metal powder or a zirconium hydride powder having an oxygen content of 1.6% or less, an ignition energy of 1 μJ to 1 mJ, a burning time of 4 s per 50 cm to 3000 s per 50 cm and an ignition point of from 160° C. to 400° C.

19. A zirconium metal powder or a zirconium hydride powder as in claim 18 which has a BET specific surface area of 0.2 to 5 m²/g and/or a mean particle size of 1 to 15 μm.

20. A zirconium metal powder or a zirconium hydride powder as in claim 18 which has a BET specific surface area of 0.2 to 5 m²/g and/or a mean particle size of 1 to 8 μm.

21. A zirconium metal powder or a zirconium hydride powder as in claim 18 which is a zirconium metal powder.

22. A zirconium metal powder or a zirconium hydride powder as in claim 18 which is prepared by a process comprising the steps of:
a) mixing zirconium oxide with solid calcium metal, solid magnesium metal, and/or solid barium metal, and mixtures of any two or more of the foregoing, to form a mixture, wherein the zirconium oxide has a mean particle size of 0.5 to 20 μm, a BET specific surface area of 0.5 to 20 m²/g and a minimum content of 94 wt %;
b) heating the mixture at 800 to 1400° C. in an oven, until a reduction reaction starts, to obtain a reaction product, wherein when forming a zirconium hydride, the reduction reaction occurs in a hydrogen atmosphere;
c) leaching the reaction product to obtain a leached product; and
d) washing and drying the leached product to yield the zirconium metal powder or zirconium hydride powder.
